(19) United States
(12) Patent Application Publication
(10) Pub. No.: US 2018/0144308 A1
(43) Pub. Date: May 24, 2018

(54) NATURAL LANGUAGE CALENDAR

(71) Applicant: Dropbox, Inc., San Francisco, CA (US)

(72) Inventor: Reginald LIPS, San Francisco, CA (US)

(21) Appl. No.: 15/359,805

(22) Filed: Nov. 23, 2016

(51) Int. Cl. G06Q 10/10; G06F 17/27

(52) U.S. Cl. CPC G06Q 10/1095; G06F 17/2785; G06F 17/2705

(57) ABSTRACT

The described calendar system receives a natural language calendar request and parses the calendar request to generate one or more request components. The calendar system determines a calendar function based on the one or more request components, such as adding a meeting, modifying a meeting, or searching a calendar for keywords. If the calendar function is a new meeting, the calendar system identifies target calendars, e.g. calendars associated with one or more meeting invitees. Using the target calendars, the calendar system determines a list of open time slots in each of the target calendars. The calendar system provides the list of open time slots to the requester who chooses a meeting time slot from the list of open time slots. In response to receiving the selection, the calendar system causes a new meeting to be added to each of the target calendars in the meeting time slot.

### TECHNICAL FIELD

The disclosed embodiments generally relate to a natural language calendar and more specifically to a natural language calendar application that receives a calendar meeting request from a requester, and automatically performs a corresponding task such as: 1) determining a list of open time slots for the meeting and provides the list of open time slots for the requester to select a meeting time; searching a target calendar; modifying or canceling an indicated meeting, or etc.

### BACKGROUND

Conventional calendar systems are complex and difficult to use. For example, some enterprise calendar systems, to setup a meeting, require a calendar requester to identify a date, a meeting duration and one or more meeting invitees, then the calendar system obtains a corresponding calendar for each invitee and displays a calendar with all of the available and unavailable time slots for all of the meeting invitees and the requester. Once displayed, the requester has to search for an open time slot. Searching for an open time slot can be difficult because the display shows all of the time slots, regardless of whether a time slot is available or unavailable for all attendees. In some calendar applications, the requester has to send a meeting invite to all of the meeting invitees to determine the availability of the meeting invitees. Once a meeting invitee receives the meeting invite, the invitee has to respond. If a meeting invitee rejects the meeting invite, the requester has to go through the process again.

### BRIEF DESCRIPTION OF THE DRAWINGS

FIG. 1 is a system diagram of a calendar system environment in accordance with an example embodiment;

FIG. 2 shows an example of a calendar user interface (UI) rendering calendar entries associated with a user of the calendar system in accordance with an example embodiment;

FIG. 3 is a flowchart showing an example method for executing a natural language calendar request in accordance with an example embodiment;

FIG. 4A shows an example of a calendar UI with a rendered meeting request in accordance with an example embodiment;

FIG. 4B shows an example UI with a rendered status message in accordance with an example embodiment;

FIG. 4C shows an example UI with a rendered list of potential invitees in accordance with an example embodiment;

FIG. 4D shows an example UI with a rendered list of open meeting time slots in accordance with an example embodiment;

FIG. 4E shows an example UI with a rendered message of a newly entered calendar entry in accordance with an example embodiment;

FIG. 5 is a flowchart showing an example method for parsing a calendar request into request components and generating one or more aggregates in accordance with an example embodiment;

FIG. 6 is a diagram showing examples of parsed calendar requests in accordance with an example embodiment;

FIG. 7 is a flowchart showing an example method for identifying one or more contacts in accordance with an example embodiment;

FIG. 8 is a flowchart showing an example method for executing a new meeting calendar request in accordance with an example embodiment;

FIG. 9 is a flowchart showing an example method for executing a search calendar request in accordance with an example embodiment;

FIG. 10 is a flowchart showing an example method for executing a calendar entry cancelation calendar request in accordance with an example embodiment;

FIG. 11A is a block diagram of a system for implementing various embodiments of the present technology in accordance with some embodiments; and

FIG. 11B is a block diagram of a system for implementing various embodiments of the present technology in accordance with some embodiments.

The figures depict various embodiments for purposes of illustrating the disclosed technology. One skilled in the art will recognize from the following description that other alternative embodiments of the structures and methods illustrated herein may be employed without departing from the principles described herein.

### DETAILED DESCRIPTION

Additional features and advantages of the disclosure will be set forth in the description which follows or can be learned by practice of the herein disclosed principles. These and other features of the disclosure will become more fully apparent from the following description and appended claims, or can be learned by the practice of the principles set forth herein.

Disclosed are systems, methods, and non-transitory computer-readable storage media for a calendar system that can perform various calendar tasks in response to calendar requests. This can be accomplished by receiving a calendar request from a requester and parsing the calendar request into one or more components (e.g. strings or n-grams). The calendar request can be a natural language request. For example, the calendar request can be “new meeting with Drew.” The calendar system can perform the parsing or identifying types of request components by matching aspects of the request components to identified component types. For example, the calendar system can use punctuation such as by using a question mark to identify that the calendar request is a search request or to identify that a request component delineated by quotes indicates a title for a new meeting. As a further example, request components can be matched to phrases in a “dictionary” that maps phrases to phrase types such as phrases that indicate durations, dates, setting a reminder, etc. or the dictionary can map phrases to a semantic meaning such as “add” or “create” being mapped to the meaning of creating a calendar entry. A phrase can be a single word or a plurality of words. For some types, the calendar system can identify a corresponding value indicated by the calendar request. For example, for a date type, the value can be a date value (e.g., a timestamp computed based on an indicated date).

In some implementations, the request components can comprise one or more contact strings, which indicate a contact identified in the calendar request. The calendar system can identify corresponding contacts associated with the requester based on the one or more contact strings. When identifying the contacts, a contact string can match more than one entry in a contact list associated with the requester. In some implementations, the calendar system can provide, to a user, a list of the contacts that match the request component so the user's selection can resolve the request component to a single contact. The identified contacts and an identification of the requester can be used to select target calendars for the calendar request.

Based on the parsing and types assigned to the parsed request components, the calendar system can determine a requested action associated with the calendar request. For example, the calendar request can be to schedule or update a meeting, cancel a meeting, search a target calendar for an item (e.g., keyword or phrase), add a reminder, etc. In some implementations, the request components can be associated with their corresponding identified type and values in a resulting data structure, referred to herein as an “aggregate.” An aggregate can also include additional data based on a count of certain action types included in the aggregate. For example, the aggregate can have an “add” type based on there being more request components of the add type than request components with other action types (e.g. search, cancel, help, etc.) in the aggregate. The aggregate can also specify an object type for certain actions, such as where the action is an “add,” the object can be what is to be added (e.g. meeting, reminder, task, etc.), which can be based on counts of the add type request components that have that corresponding object.

When the calendar request is a request to setup a meeting with one or more contacts (e.g. the aggregate has a type of add and an object of meeting), the calendar system can setup a new meeting with those contacts. In some implementations, the calendar system can do this by accessing the target calendars and choosing one or more time slots for the meeting that satisfy the criteria in the calendar request (e.g., date, duration, types of windows and that are open on each accessed calendar). The calendar system can automatically select one of the chosen time slots or can output a list of the chosen time slots and receive a user selected time slot. Once a time slot is selected, a calendar entry can be inserted into each of the target calendars or invitees can be sent to users associated with each of the target calendars. In some implementations, a meeting notification, e.g., an email or text message, can be sent to the meeting participants informing them of or asking them to confirm the new calendar entry.

When the calendar request is a request to perform a search, the calendar system can search target calendars for one or more “search terms” identified in the calendar request. To perform a search, the calendar system can identify one or more target calendars from the calendar request and execute a search for the search term. For example, if a calendar request is “search for ‘patronus’ in Reginald's calendar,” the calendar system can identify Reginald and his calendar as the target calendar. In another example, if a calendar request is “search for ‘patronus,’” the calendar system can then identify the requester and the calendar associated with the requester as the target calendar. In these examples, the calendar system can search the target calendar for calendar entries that contain “patronus.” The calendar system can then cause the rendering of the search results. For example, a list of calendar entries containing the search term can be rendered.

When the calendar request is a request to cancel a calendar entry, the calendar system can identify the calendar entry to be canceled and identify any meeting participants in the calendar request. The calendar system can then cancel the calendar entry. For example, if the calendar request is “Cancel my Tuesday meeting,” the calendar system can identify the calendar entry and identify the calendar entry corresponding to the calendar request. If the requester has multiple calendar entries for the identified date, the calendar system can prompt the requester to select the calendar entry to be canceled. The calendar system can then cause the calendar entry to be removed from the calendars of any participants associated with the calendar entry. For example, if the requester, Bob Smith and Susan Smith have a meeting scheduled for Tuesday, the calendar entry for the meeting can be removed from the calendars associated with the requester, Bob Smith and from the calendar of the participant, Susan Smith. In some implementations, the calendar system can provide an indication that the targeted calendar entry is canceled. For example, the calendar entry can be shown in a different color (e.g., red) or different shade from other calendar entries to indicate that the calendar entry is canceled. In some implementations, the targeted calendar entry can have an “X” in the corresponding time slot to indicate that the calendar entry is canceled. Other indications can be used to show a canceled calendar entry. In some implementation, the targeted calendar entry can be shown as an open time slot. In some implementations, the requester can be prompted to confirm the identified calendar entry prior to canceling the calendar entry.

When the calendar entry is a request to modify a calendar entry, e.g., re-schedule or to shift the meeting time, add or remove invitees, etc., the calendar system can identify the originally scheduled calendar entry and can obtain the target calendars of the contacts associated with the originally scheduled calendar entry. The calendar system can check the targeted calendars to ensure that the modification has no conflicts in the targeted calendars. For example, if the requester requests that a meeting be extended an hour, the calendar system can check to see if all of the participants have any conflicts. If any of the participants have a conflict due to the modification of the calendar request, the request to modify the calendar entry can be treated as a new meeting request and can identify open time slots for a meeting in accordance with the duration of the request and the target calendars of the participants. Otherwise, the calendar system can modify the calendar entries in accordance with the desired modification, e.g., extend the meeting time in each of the targeted calendars. In some implementations, a meeting notification, e.g., an email or text message, can be sent to the meeting participants notifying them of the modification or new meeting time.

The disclosed technology addresses the need in the art for an efficient calendar application that is easy to use compared to conventional calendar systems. The disclosed embodiments are related to a calendar system or electronic calendar system that allows a requester to use natural language calendar requests to interact with the calendar system. A natural language calendar request is a calendar request that comprises an entry without the requester having to use drop down menus and/or multiple selections to have a calendar request executed. For example, a natural language calendar request can be, “schedule a meeting with bob for next Monday.” The natural language calendar request can be a typed entry or an audio entry. The requester can be prompted to identify one or more participants and/or to select a time slot from a list of available time slots. In conventional calendar systems, the requester would have to use one or more menus and/or widgets to enter a similar calendar request. For example, in a traditional calendar system, the calendar requester may have to choose a date, time, and participants. In some conventional calendar systems, once the participants are chosen, a meeting invite may be sent to each of the participants to determine their availability. In other conventional calendar systems, the requester can be presented with a representation of a calendar showing a collective calendar having calendar entries for all of the identified participant and the requester has to identify an open time slot and select a desired time slot. In contrast, various of the disclosed embodiments can automatically provide a list of open time slots for the requester to select a desired time slot from the list of open time slots. Since the calendar system is electronic, the calendar system can access one or more calendars stored on a server with the calendar system identifying one or more open slots among the accessed calendars. The calendar system can then output (e.g., on a display or through audio) a list of open time slots for the requester to select a desired time slot. As a result, the disclosed embodiments, can provide an efficient electronic calendar system that uses natural language calendar requests. These features can provide users with faster and more accurate interactions than are afforded by conventional systems that require multiple inputs and additional stages to successfully interact with digital calendars. Thus, the disclosed embodiments, addresses a need in electronic calendar systems for an efficient electronic calendar system for handling calendar requests which can be natural language calendar requests.

### System Overview

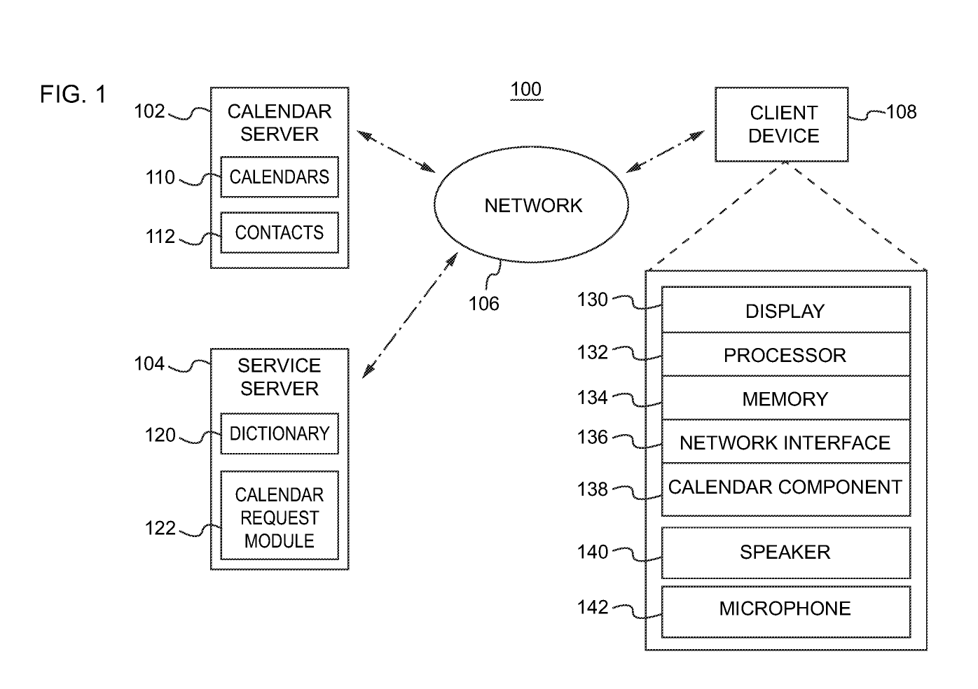

Referring to FIG. 1, a system diagram of a calendar system environment in accordance with an exemplary embodiment is illustrated. As shown, the calendar system environment 100 can include a calendar server 102, a service server 104, a network 106, and a client device 108. Although the calendar server 102, service server 104, network 106 and client device 108 are shown logically as single instances, these systems can be server or client computing devices and can each be a distributed computing environment encompassing multiple computing devices located at the same or at geographically disparate physical locations. For example, each server 102 or 104 can correspond to a group of servers. The calendar server 102 can store calendars 110 for one or more users (e.g. one or more individuals, one or more user accounts for individuals, one or more user accounts for organizations, one or more scripts or programs, etc.). The one or more users can be individuals or can be associated with an organization such as a company, enterprise, university, school, or the like. For example, the calendar server 102 can host an enterprise calendar such as, Google Business Calendar by Google of Mountain View, Calif. The calendar server 102 can include one or more contact lists 112 associated with the one or more users. The calendar server 102 can process one or more calendar requests on behalf of the service server 104 and/or one or more client devices 108.

In some implementations, the service server 104 can process calendar requests and provide commands to calendar server 102 or client device 108 to perform the actions indicated in the calendar requests. Calendar server 102 can include calendars 110 and contacts 112. Calendars 110 or contacts 112 can be associated with one or more user accounts. The service server 104 can include dictionary 120 and/or a calendar request module 122. Calendar request module 122 which can communicate with the calendar server 102 and/or one or more client devices 108 via the network 106. The calendar request module 122 can execute one or more functions associated with a calendar component 138 associated with a calendar application residing on a client device 108. In some implementations, the calendar request module 122 can interact with the calendar server 102 to execute one or more functions associated with the calendar application residing on the client device 108. In some implementations, the service server 104 can process one or more calendar requests provided by one or more client devices 108. In some implementations, the service server 104 can interact with the calendar server 102 to carry out one or more calendar requests. In some implementations, calendar server 102 and service server 104 can be implemented by the same server or server group such that the server or server group has each of components 110, 112, 120 and 122. Furthermore, in some implementations, functionality described herein as implemented at client device 108 or at calendar server 102 or service server 104 can be performed by any other of these systems. For example, while an implementation may be described herein as receiving a calendar request at client device 108, sending the text of the calendar request to service server 104 for parsing and generating calendar commands, which service server 104 sends to calendar server 102, it should be understood that these described acts can be performed by alternate devices, such as the parsing being performed by calendar component 138 of client device 108, using a local version of dictionary 120, such that calendar commands are provided to a combined server 102/104, which uses calendar request module 122 to carry out the indicated instructions to modify or search a calendar 110.

The calendar server 102 and/or service server 104 can support connections from a variety of different client devices 108. Client devices 108 can be of varying types, capabilities, operating systems, etc. Furthermore, the calendar server 102 and/or service server 104 can concurrently accept connections from and interact with multiple client devices 108.

The network 106 can be any suitable communications network for data transmission. The network 106 can be one or more communication networks, such as, a local area network (LAN) or other suitable communication networks (e.g., the Internet, a metropolitan area network (MAN), a wide area network (WAN), a mobile, a wire or wireless network, a private network, a virtual private network, etc.

Client devices 108 generally include devices and components for communicating with the calendar server 102, service server 104 and a user of client device 108. Client devices 108 can be a cellular phone, a personal digital assistant (PDA), a wired or wireless modem, a wireless communication device, a handheld device, a computer, a tablet computer, a laptop computer, a cordless phone, a wearable item such as a watch or glasses, or the like. Each client device 108 can include any of a display 130, one or more processors 132, memory 134, network interface 136, calendar component 138, speaker 140, or microphone 142. The display 130 can provide information to a user, and in certain client devices 108 the display 130 can be a touchscreen, projection, or heads-up display. The client device 108 can include one or more processors 132 for executing software, modules and/or components. Client device 108 can include memory 134 for storing data described herein and/or local versions of applications or communications with other components and/or one or more subcomponents that are executed by the one or more processors 132. One or more contact lists can be stored in the memory 134 of a client device 108. The memory 134 can include any type of computer-readable medium usable by a computer or processor 110, such as random access memory (RAM), read only memory (ROM), tapes, magnetic discs, optical discs, volatile memory, flash or other non-volatile memory, or any combination thereof. In an aspect, for example, the memory 134 may be a computer-readable storage medium (e.g., a non-transitory medium) that stores one or more computer-executable codes for executing one or more functions of a component, such as the network interface 136 and the calendar component 138. The client device 108 can include a network interface 136 for communicating with the calendar server 102, the service server 104, or other client devices 108, e.g., via the network 106. The network interface 136 can include a transceiver (not shown) for transmitting and/or receiving one or more communications with the calendar server 102 and/or service server 104 via the network 106 through one or more network entities (not shown). As explained below, the network interface 136 can communicate with the calendar server 102 and/or service server 104 to obtain information to execute one or more calendar functions. The calendar component 138 can execute one or more functions associated with a calendar application residing on a client device 108. The speaker 140 can audibly provide information to a user. The microphone 142 can receive audible information and/or commands from a user. For audible commands, a keyword or phrase can be used to trigger the calendar component 138. For example, an audible command can start with “Time genius,” “Genius” or any other trigger word or phrase to trigger a dictation function. Alternatively, if the user causes the mobile device 108 to enter a dictation mode (e.g., by double tapping a function key), the requester can enter a calendar request. Other components of a client device 108 that are not material are not shown, for example, local fixed memory (RAM and ROM), as well as optionally removable memory (e.g., SD-card) and power sources. The hardware features described above in relation to client device 108 can also be implemented by servers 102 or 104.

The dictionary 120 can include words or phrases to identify one or more strings associated with a calendar function. The dictionary 120 can be stored e.g., in memory of the calendar server 102 or memory of service server 104 or in memory 134 of the client device 108. For example, the dictionary 120 can include mappings of a semantic (indicated below with a #) to terms (shown below following the corresponding semantic), such as the following mappings:

# add
add; create; calendars; setup; set up; new; make; making
# cancel
delete; remove; cancel
# search
search; what; what's; whats; when; tell me; ?; show me; show
# help
what can you do; what do you do; help
# meeting
meeting; meetings; calendars; event; 1:1; one on one; 1 on 1; appointment;
appointments;
meetup; celebration; rdv; rendez-vous; party; bash; spree
# reminder
reminder; reminders; memo; memos
# search, meeting
get my calendars
# add, meeting
meet; meet up; create meeting; create a meeting; create new meeting;
create a new meeting; meet
up; calendars meeting; calendars a meeting; calendars new meeting;
calendars a new meeting;
add meeting; add a meeting; add a new meeting; new meeting
# add, reminder
create reminder; create a reminder; create new reminder; create a new
reminder; remind me
# cancel, meeting
cancel meeting; cancel a meeting; remove meeting; remove a meeting;
delete meeting; delete a
meeting
# compliment
you rock; you are awesome; you're awesome; you are great; you're
great

The calendar component 138 can be a stand-alone application, one or more application plug-ins, a client side calendar application, a webpage, and/or a browser extension that is used to communicate with the calendar server 102 and/or service server 104 via the network interface 136. The calendar component 138 can provide a calendar user interface (UI) for the user to interact with the calendar server 102 and/or service server 104. For example, a user can interact with the calendar server 102 and/or service server 104 via the calendar component 138, via the network interface 114, and/or via a webpage displayed using a web browser application. The calendar component 138 can be configured to communicate with the calendar server 102 and/or the service server 104 to perform one or more calendar functions/requests. The calendar requests can include, but are not limited to, requests to schedule a meeting, re-schedule a meeting, cancel a meeting, search a calendar for an item (e.g., keyword or phrase), get help, add a reminder, re-schedule a reminder, cancel a reminder, or provide a compliment. Examples of calendar requests are “meet up with John, Bob and Sarah tomorrow,” “what's my schedule tomorrow?,” “show me john's schedule,” “search for ‘patronus’ in Reginald's schedule,” “tell me about my schedule,” or “new one on one with Bob.”

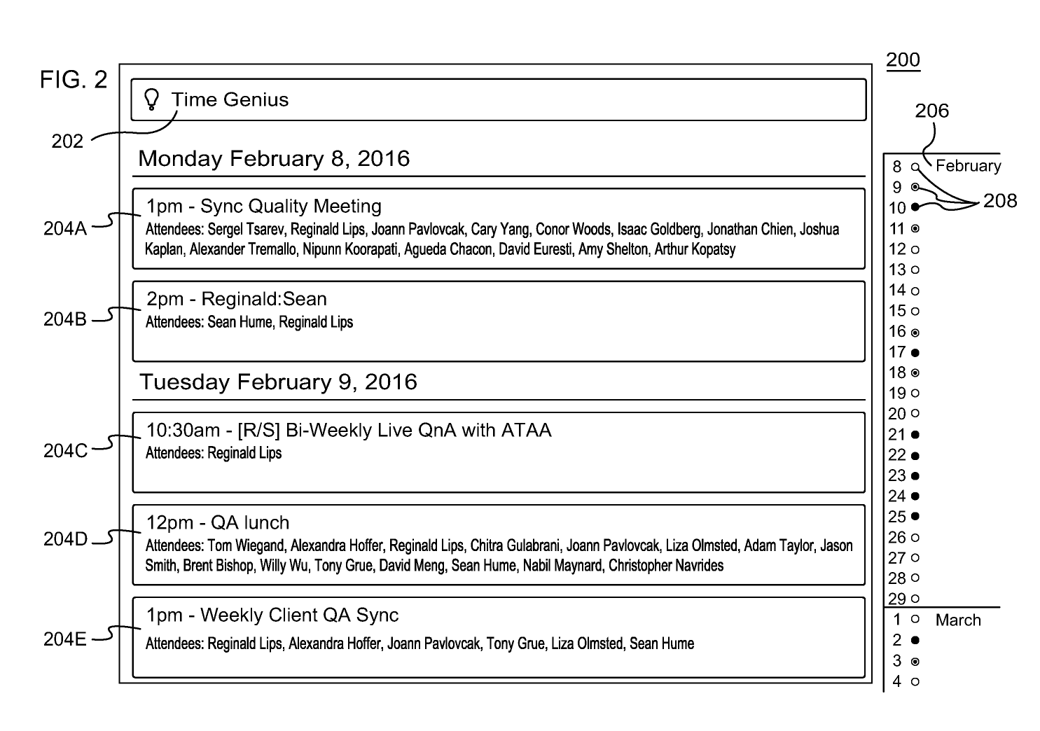

FIG. 2 illustrates an example of a calendar interface in accordance with some embodiments. As shown, a calendar UI 200 is rendered on a display 130 of a client device 108. The calendar UI 200 can include a prompt 202 (e.g., “Time Genius”), calendar entries 204A-E in a vertical ordered list and a vertical calendar 206. The prompt 202 can be used to enter calendar requests. In some implementations, calendar requests can be entered verbally, a representation of which may or may not be provided in UI 200. The calendar entries 204A-E can be displayed in a vertical list with the calendar entries separated by dates with each calendar entry including a start time and/or an end time. In some implementations, calendar entries can include a subject and/or an invitee list. For example, as shown, there are five displayed calendar entries with two 204A and 204B on Monday, Feb. 8, 2016 and three 204C-204E on Tuesday, Feb. 9, 2016. The vertical ordered list can be ordered in time with the earliest calendar entry being first. In some embodiments, more or less information can be displayed. The number of calendar entries 204 that are displayed can be limited, such as based on a predetermined number of calendar entries (e.g., the next ten calendar entries), a predetermined number of days (e.g., the next five days) and/or can be limited based on device characteristics. For example, a client device 108 that has a large display 130 can display more calendar entries 204 (e.g., ten calendar entries) than a client device 108 that has a small display 130 which can display less calendar entries 204 (e.g., five calendar entries). In some implementations, the displayed calendar entries 204 can be scrolled. For example, the user can scroll down the list of calendar entries to see later calendar entries.

The calendar UI 200 can include a vertical calendar 206 listing each day along with an indicator 208. The vertical calendar 206 can start with the current day and proceed in consecutive order. The number of days can be limited to a predetermined number of days or can be limited based on device characteristics. The indicator 208 can indicate a representation of the number of calendar entries for each day. The indicators 208 can be color coded, different fills, different shapes, a number or any other type of indicator to indicate a number or range of calendar entries for that day. For example, a green indicator can indicate zero calendar entries, a yellow indicator can indicate one to three calendar entries and a red indicator can indicate four or more calendar entries. In another example, a non-filled indicator can indicate zero calendar entries, a partially filled indicator can indicate one to three calendar entries and a filled indicator can indicate four or more calendar entries. Combinations of these and other indicator types can be used. In some implementations, the indicators 208 can be pre-determined and cannot be modified. Alternatively, in some implementations, a user can modify the number of calendar entries or range of calendar entries for one or more indicators 208. In some implementations, more or less levels of indicators can be used with each indicator 208 having a different number or range of calendar entries.

Communications between the client devices 108, the calendar server 102, and/or service server 104 can be done through one or more Application Programming Interface (API) calls. For example, an API call can be used to obtain contact lists, operate on contact calendars, or access a mapping dictionary.

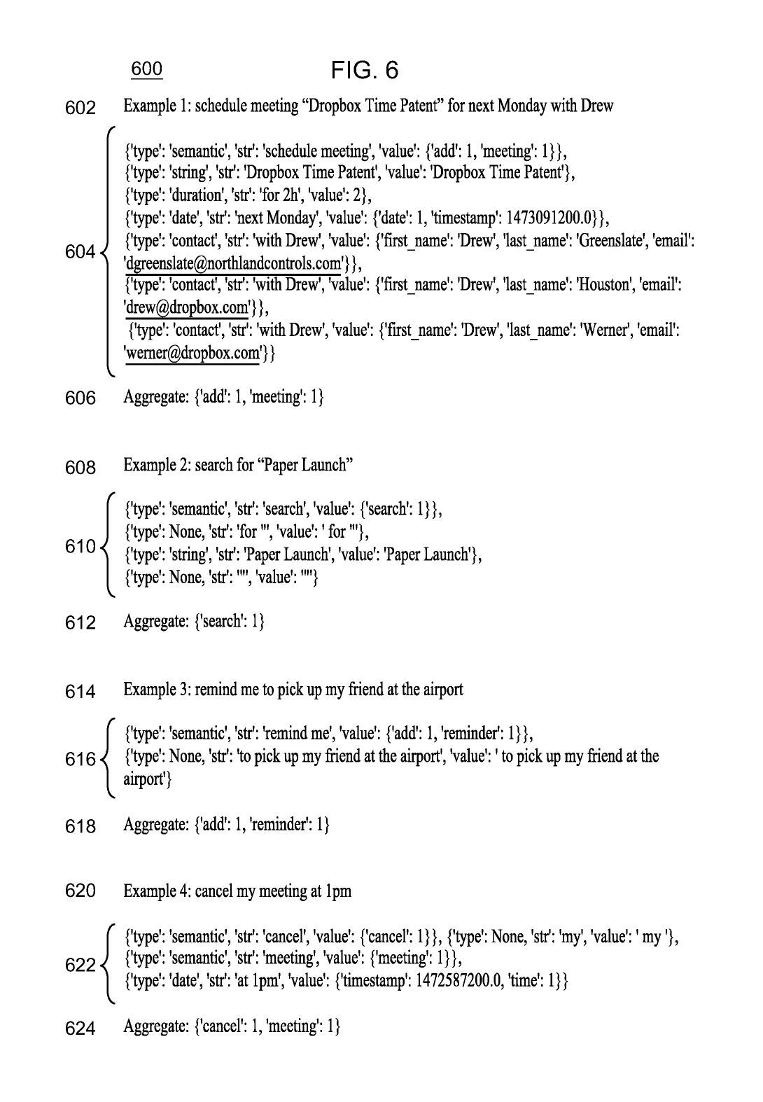

In order to process a natural language calendar request, the calendar request can be parsed into one or more request components. For example, the calendar request module 122 can use rules to identify substrings for these request components such as rules that identify components from: sections identified between quotation marks, sections with words that indicate durations, or sections with words that indicate dates. The calendar request module 122 can then further parse the calendar request using a dictionary 120 to identify, from remaining sections of the calendar request, semantics that match keywords or phrases in the dictionary 120. FIG. 6 shows four different examples of parsing a calendar request and is explained below in more detail. Thus, as shown below, the request components can include, but are not limited to, one or more of the following: semantic, duration, date, contact, location and subject.

A semantic or a semantic request component can identify the type or concept of a calendar request. The type of calendar requests can indicate an associated action to take, such as scheduling a meeting, re-scheduling a meeting, canceling a meeting, searching target calendars for an item (e.g., keyword or phrase), getting help, adding a reminder, re-scheduling a reminder, canceling a reminder, or complimenting the system.

A duration request component can identify a duration of a meeting. If a duration is not included in a calendar request, then a default meeting duration can be used or a user can be prompted to provide one. For example, the default duration can be a half hour. In some implementations, the user can change the default duration.

A date request component can be a timestamp or other date indicator indicating the date and start time for a meeting. In some implementations, the calendar request module 122 can compute a date indicator, such as a timestamp, based on relative terms in the calendar request. For example, if the date request component is based on a substring indicating a meeting should be created “tomorrow” or “next Tuesday” these can be converted into a timestamp that is not relative to the time the request was created.

A contact request component can identify one or more potential contacts or meeting invitees identified in the calendar request. The contacts can be determined based on one or more contact lists. The one or more contact lists can reside on the calendar server 102, service server 104, and/or client devices 108. The one or more contact lists can be imported. For example, when a user sets up a calendar, the user can import one or more contact lists to the calendar server 102, service server 104 and/or client devices 108. The one or more contact lists can include identified contacts that the requester has communicated with, previously had meetings with or received meeting invites from, etc.

A location request component can identify a location for a meeting, such as a meeting room, conference call, and/or location, such as the building, landmark, town, or address where a meeting may occur. A subject request component can be the subject or title of a meeting.

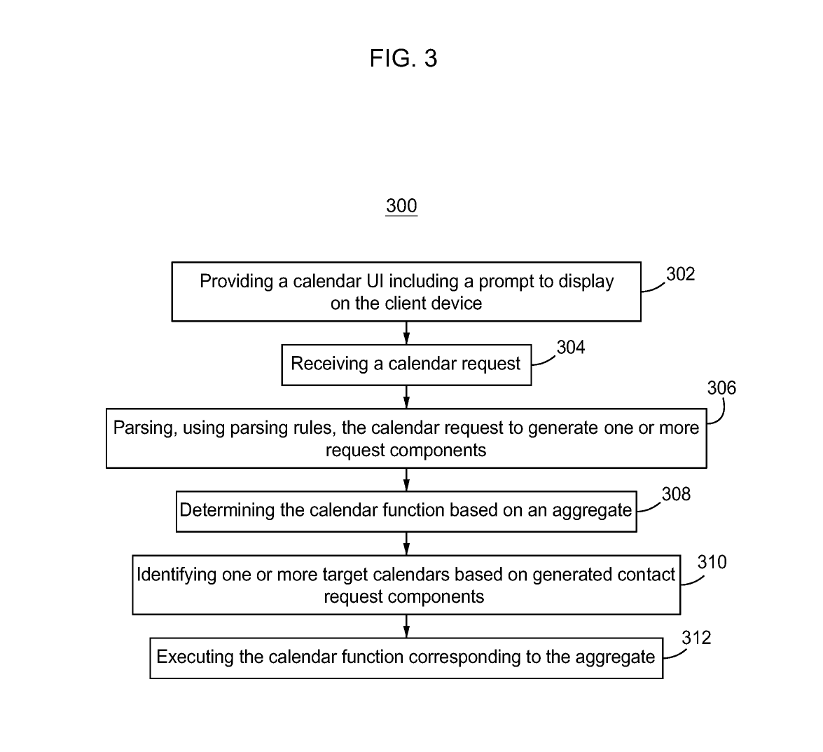

The components and examples illustrated in FIGS. 1, 2, 4, 6, 11A and 11B, and in each of the flow diagrams discussed in FIGS. 3, 5 and 7-10, can be altered in a variety of ways. For example, the order of the logic may be rearranged, substeps may be performed in parallel, illustrated logic may be omitted, other logic may be included, etc. In some implementations, one or more of the described components can execute one or more of the described processes.

FIG. 3 illustrates a flowchart for a method 300 for executing a natural language calendar request in accordance with some embodiments. Method 300 is provided by way of example, as there are a variety of ways to carry out the method. In some implementations, method 300 can be carried out using the configurations illustrated in FIG. 1, and various elements of these figures are referenced in explaining exemplary method 300. Exemplary method 300 can begin at block 302.

At block 302, method 300 can provide a calendar UI including a prompt, the providing causing the UI to be displayed on a display on a client device. FIG. 2 shows an example of a rendered calendar UI 200 on the display 130 of client device 108. After providing the calendar UI, the method 300 can proceed to block 304.

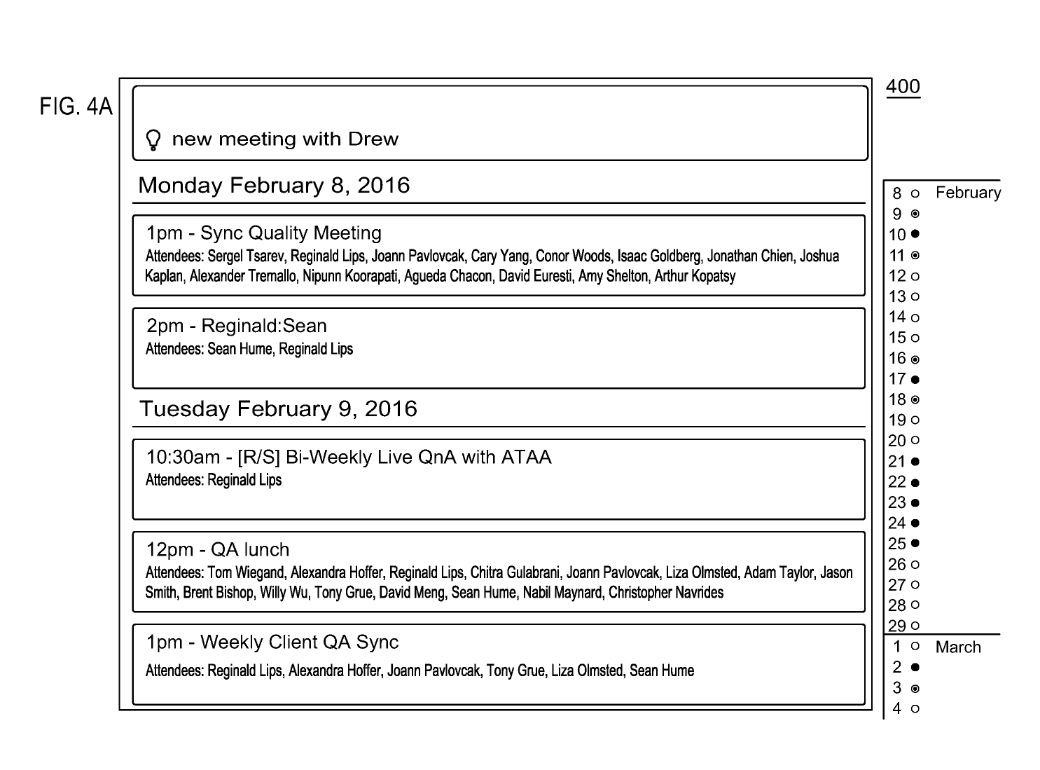

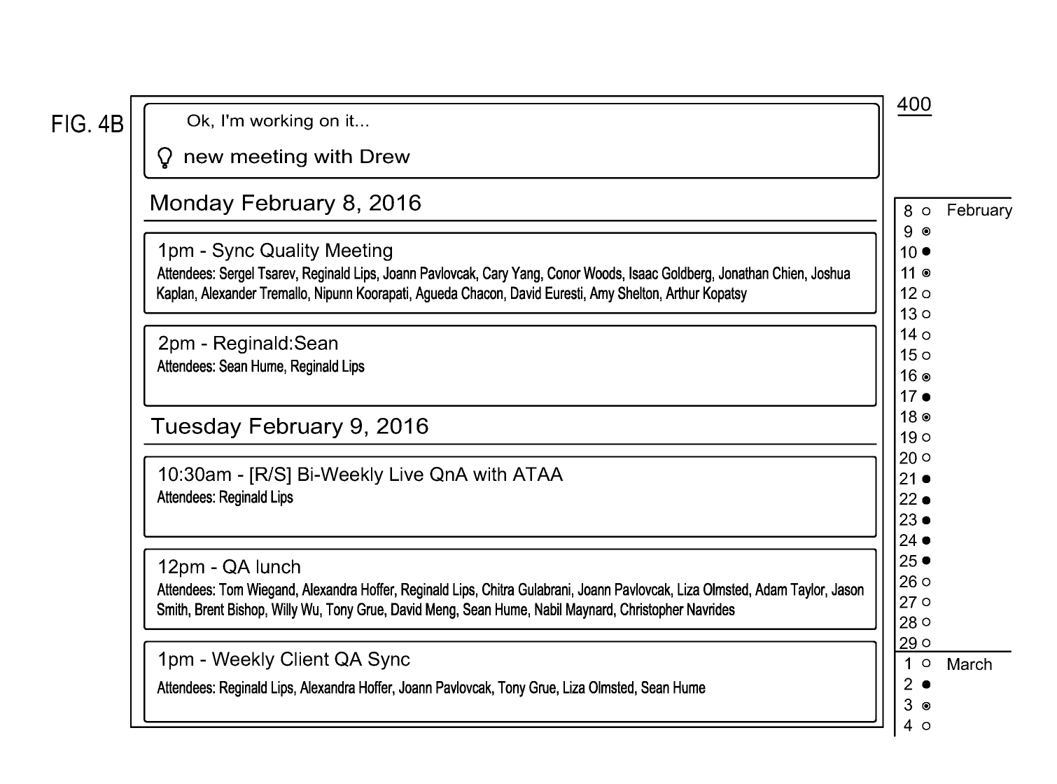

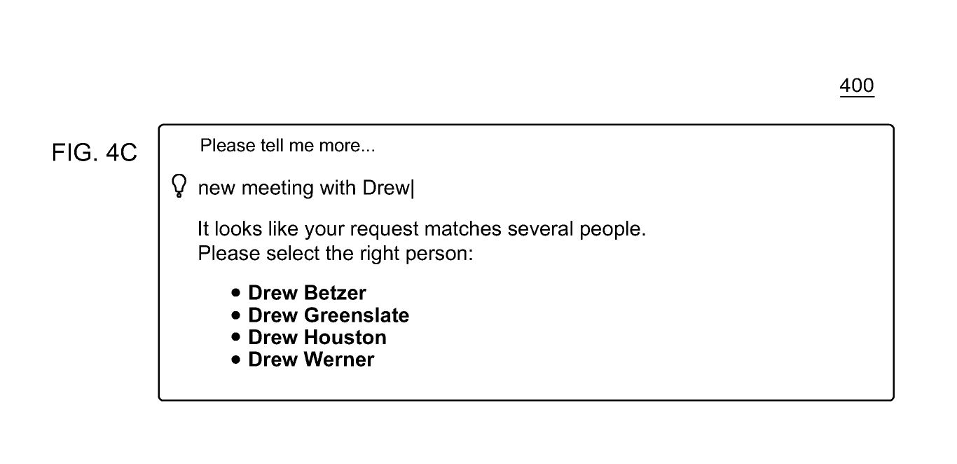

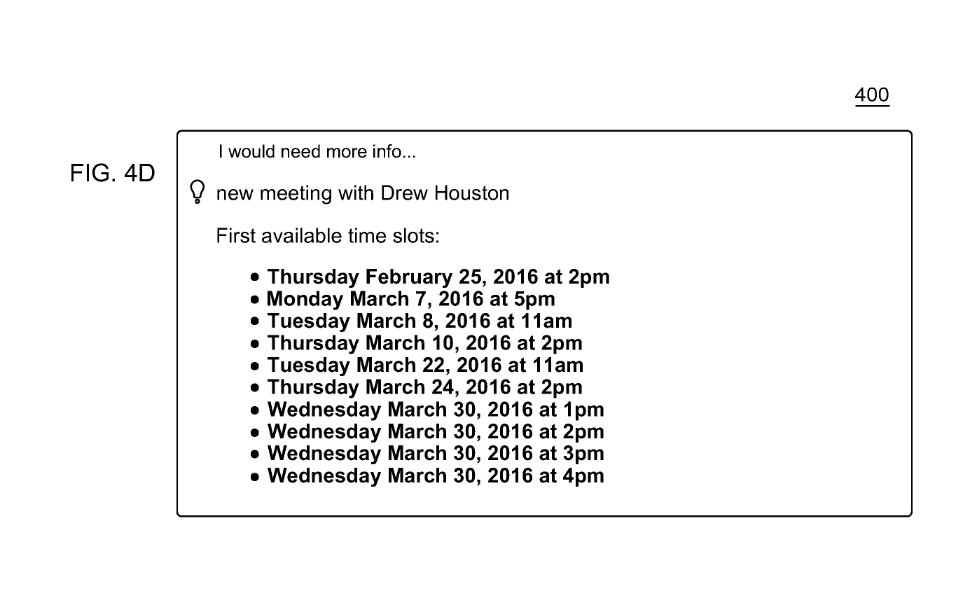

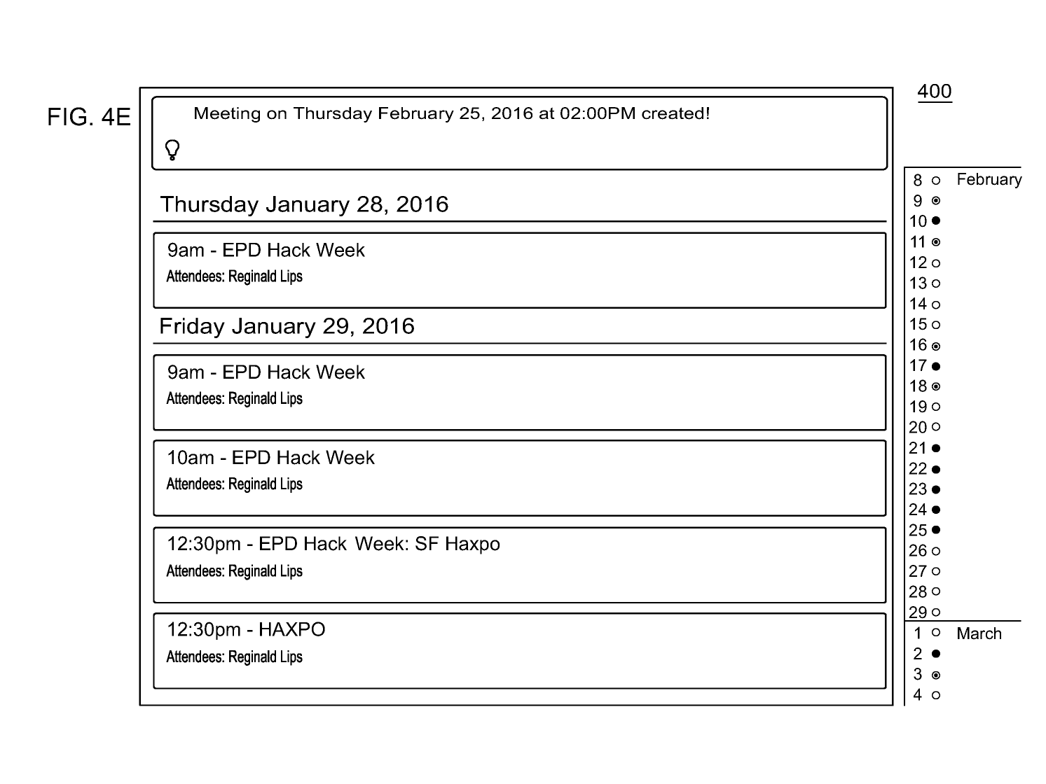

At block 304, method 300 can receive a calendar request. For example, using the processor 132, the calendar component 138 of the client device 108 can receive using input indicating a calendar request which can be sent, using network interface 136, and received, e.g. by service server 104, at block 304. In various implementations, a calendar request can be provided to client device 108 as text or audio. FIG. 4A shows an example textual calendar request: “new meeting with Drew.” In some implementations, an audible calendar request can start with a keyword or phrase, such as, “Time Genius” or “Genius.” For example, a requester can say, “Time genius, new meeting with Drew” or “Genius, meet up with Reginald on Monday.” Audible calendar requests can be received via the microphone 142 on the client device 108. In some implementations, client device 108 can include, with the calendar request, a requester identifier or a time stamp. The requester identifier can be used to identify a user who initiated the calendar request. For example, the requester identifier can be an email address associated with the requester. The time stamp can be used to determine a date and/or time the calendar request was made. For example, the time stamp can be used to determine which “Monday” or “Monday at 3 PM” a requester is referring to. After receiving a calendar request, the method 300 can proceed to block 306.

In some implementations, while the calendar request is being processed, client device 108 can render a status message. For example, in FIG. 4B, a status message of “Ok, I'm working on it” is rendered on the display 130 of the client device 108. In another example, a status message can be: “Sit tight! I'm looking into that.” In some implementations, other messages can be displayed.

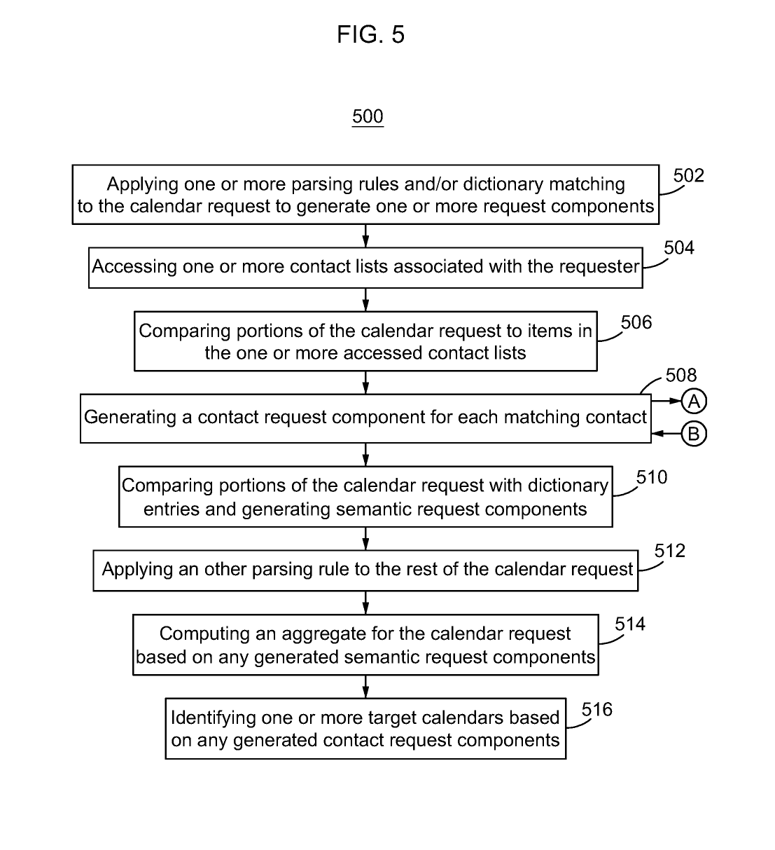

At block 306, method 300 can parse the calendar request to generate one or more request components. In various implementations, the request components can include title or other string components, location components, duration components, date components, semantic components, contact components, or components to be ignored (e.g. “none” components). In some implementations, using the processor, 132, the calendar component 138 of the client device 108 can parse the calendar request to generate the request components. In some implementations, the client device 108 can provide the calendar request to the calendar server 102 or the service server 104. The calendar server 102 or the service server 104 can parse the calendar request, at block 306, to generate the request components. Additional details regarding parsing the calendar request are provided below in relation to FIG. 5. Parsing the calendar request to generate one or more request components can be referred to as mapping. After parsing the calendar request to generate the request components, the method 300 can proceed to block 308.

At block 308, method 300 can determine the calendar function based on an aggregate. In some implementations, using the processor 132, the calendar component 138 of the client device 108 can determine the calendar function based on an aggregate. In some implementations, the calendar server 102 or the service server 104 can determine the calendar function based on an aggregate. FIG. 5 provides details regarding how the aggregate is generated. The aggregate identifies the calendar function to be performed, e.g., add a meeting, conduct a search or cancel or modify an existing meeting. After determining the calendar function based on the aggregate, the method 300 can proceed to block 310.

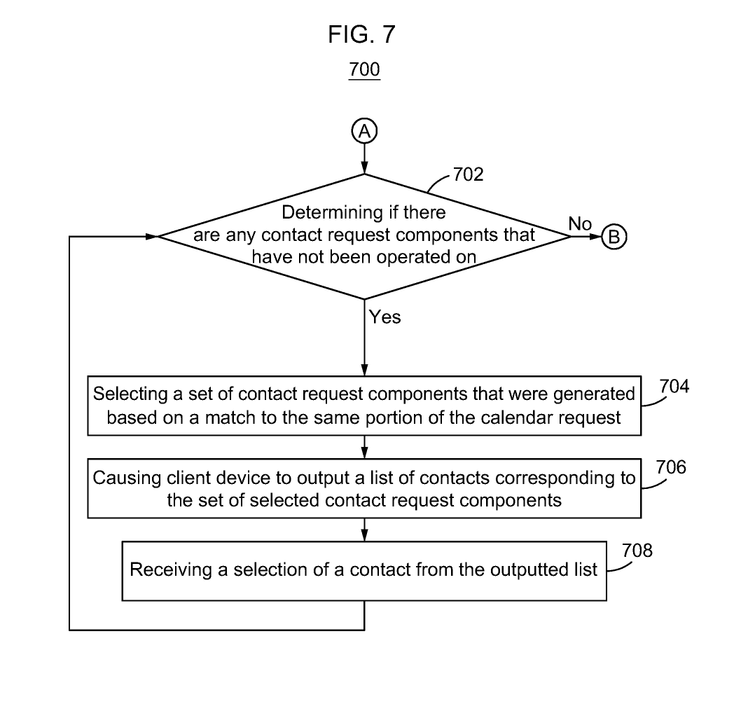

At block 310, method 300 can identify one or more target calendars based on the contact request components. In some implementations, using the processor 110, the calendar component 138 of the client device 108 can identify the one or more target calendars. In some implementations, calendar request server 102 or the service server 104 calendar request can identify the target calendars. FIG. 5 provides details regarding how the contact request components are generated and FIG. 7 provides details regarding how the generated request component can be reduced when multiple contact request components are generated for a contact. Target calendars can be the calendars of invitees to a new or updated meeting, one or more calendars to perform a search on, the calendar of the requester, and/or calendars of contacts otherwise identified in the calendar request. In some implementations, the target calendars can also include a calendar associated with the user who made the calendar request. After identifying the target calendars, the method 300 can proceed to block 312.

At block 312, method 300 can execute the calendar function corresponding to the aggregate. In some implementations, using the processor 132, the calendar component 138 of the client device 108 can execute the calendar function corresponding to the aggregate. In some implementations, the calendar server 102 and the calendar request module 122 can execute the calendar function corresponding to the aggregate. FIGS. 7-10 provide examples of executing an add a meeting request, conduct a search request and cancel a meeting request, respectively.

FIG. 5 illustrates a flowchart for parsing a calendar request to generate one or more request components in accordance with some embodiments. Method 500 is provided by way of example, as there are a variety of ways to carry out the method. Method 500 described below can be carried out using the configurations illustrated in FIG. 1 by way of example, and various elements of these figures are referenced in explaining method 500. Exemplary method 500 can begin at block 502.

At block 502, method 500 can apply one or more parsing rules and/or dictionary matching to the calendar request to generate one or more request components. In some implementations, using the processor 132, the calendar request module 122 can apply one or more parsing rules and/or dictionary matching to the calendar request to generate one or more request components. In some implementations, the service server 104 and the calendar request module 122 can apply one or more parsing rules and/or dictionary matching to the calendar request to generate one or more request components. As explained below, the rules can include a title parsing rule, duration parsing rule, location parsing rule, exclude parsing rule and other parsing rule. The dictionary can contain terms, e.g., text and/or phrases, to assist with the parsing. The dictionary can be dictionary 120 or request component specific dictionaries (e.g., title parsing dictionary, duration parsing dictionary, location parsing dictionary). The terms in the dictionary can be static, adaptive, structured, or populated via training using calendar requests. The dictionary matching can be exact matching or threshold matching. Exact matching can require the text or phrases in the calendar request to be identical to text or phrases in the dictionary. Threshold matching can use regular expressions, wildcards and/or related words. A wildcard can be used to represent a number of characters, e.g., meet*, where the * is the wildcard and can capture meet, meets, meeting, etc. Related words can include variations of a word, such as “ave” could match with “avenue.”

A title parsing rule can find text or phrases between quotes in the calendar request to identify a string (title) type request component. For example, if the calendar request is: schedule meeting “Dropbox Time Patent” for 2 h next Monday with Drew, the “Dropbox Time Patent” would be identified as the string (title) type request component.

A duration parsing rule can generate a duration type request component using dictionary matching. For example, the calendar request module 122 can compare text and/or phrases in the calendar request with terms in the dictionary to generate the duration type request component. The dictionary can include terms or regular expressions that are associated with the duration type request component. For example, the dictionary can include numbers and a letter (e.g., 15 m, 30 m, 0.5 h, 1 h), numbers and words (e.g., 15 minutes, 30 minutes, half hour, 1 hour), words and or phrases (fifteen, half hour, one hour), wildcards (*min, *minutes, *h, *hour*) or any other terms related to durations. For example, using the previous calendar request, the “2 h” would be identified as the duration type request component. This match could be to a calendar entry that includes the regular expression [0-2][0-9]h∥[0-9]h, indicating a match to an set of characters that had the numbers 0-29 followed by an “h.”

A date parsing rule can generate a date type request component using dictionary matching. For example, the calendar request module 122 can compare text and/or phrases in the calendar request with terms in the dictionary to generate the date type request component. The dictionary can include terms that are associated with the date type request component. For example, the dictionary can include words (e.g., Monday, Tuesday, Wednesday, Thursday, Friday, Saturday, Sunday, next, this, tomorrow, day after tomorrow), calendar related words (January, February, March), wildcards (January *, February*, March*) or any other terms related to dates. For example, using the previous calendar request, the “next Monday” would be identified as the date type request component. Furthermore, regular expression entries in the dictionary can be configured to match formats such as “09/28/1983,” “2016-12-25,” or “Oct. 31, 2013.”

A location parsing rule can generate a location type request component using dictionary matching. For example, the calendar request module 122 can compare text and/or phrases in the calendar request with terms in the dictionary to generate the location type request component. The dictionary can include terms that are associated with the location type request component. For example, the dictionary can include cities (San Francisco, Palo Alto, Los Angeles), streets (Brannan, Main, First, 1^{st}), conference rooms (e.g., main, Franklin, corner), addresses (e.g., 123 main street, 124 first ave, 125 orange blossom boulevard), landmarks (e.g., main office, satellite office, mel's diner), or any other terms related to location.

An exclude parsing rule can generate a none type request component using dictionary matching. For example, the calendar request module 122 can compare text and/or phrases in the calendar request to generate the none type request component. The dictionary can include text and/or phrases that are unnecessary. For example, the dictionary can include text, e.g., a, an, the, my, please or quotes (“,”, ‘, or’). The exclude parsing rule can identify text or phrases that can be ignored or excluded from the calendar request.

Returning to FIG. 5, at block 504, method 500 can access one or more contact lists associated with the requester. In some implementations, using the processor 110, the calendar component 138 of the client device 108 can access one or more contact lists associated with the requester. The one or more contact lists can be stored in memory 134 of the client device 108. In some implementations, the calendar server 102 or the service server 104 can access one or more contact lists associated with the requester. In various implementations, the contact lists can be associated with the requester as a personal contact list of the requester; as a recorded history of contacts the requester has contacted, had meetings or other calendar events with, has shared content items with, has “friended,” or etc.; as a list of people in an organization associated with the requester (e.g. co-workers identified by an employee list); or etc. After accessing the one or more contact list associated with the requester, the method 500 can proceed to block 506.

At block 506, method 500 can compare portions of the calendar request to items in the one or more accessed contact lists. In some implementations, using the processor 110, the calendar component 138 of the client device 108 can compare portions of the calendar request to items in the one or more accessed contact lists (using contact lists local to the client device or by querying contact lists located on a server). In some implementations, the calendar server 102 or the service server 104 can compare portions of the calendar request (or text that has not been assigned other request components using other rules) to items in the one or more accessed contact lists. As a result of the comparisons, method 500 can identify contact request components from portions of the calendar request that match one or more items in the one or more accessed contact lists. In some implementations, this matching is accomplished by selecting contacts that have a first and/or last name that matches a substring of the calendar request. In some implementations, a “match” can occur when the compared fields are the same. In some implementations, a “match” can occur when the compared fields have identity above a threshold amount, which can account, for example, for spelling errors, differences in common name spellings, etc. In some implementations, a portion of the calendar request can match multiple contact list items. In this situation, in some implementations, method 500 can select all the matching contact list items. In this situation, in other implementations, method 500 can select a subset of the matching contact list items, e.g., based on a determined affinity between the requester and the contact (such as based on frequency of messaging or sharing, number of friends in common, an identified familial, work, or other relationship between the requester and the contact(s), etc.); an identified tendency of the requester to perform particular types of calendar operations in relation to the matching contact(s); etc. The calendar server 102, service server 104 and/or client device 108 can identify one or more contacts whose name matches a contact entry in the one or more contacts lists and can obtain the email address for the each identified contacts. After comparing portions of the calendar request to items in the one or more accessed contact lists, the method 500 can proceed to block 508.

At block 508, method 500 can generate a contact request component for each matching contact selected at block 506. In some implementations, using the processor 110, the calendar component 138 of the client device 108 can generate a contact request component for each match. In some implementations, the calendar server 102 or the service server 104 can generate a contact request component for each match. In this situation, in some implementation, a full name for contact request component can be identified and can be encapsulated in the contact request component data structure, e.g., as tagged data. For example, the calendar request of FIG. 4B can generate four different contact request components for four contacts that match a portion of a calendar request that includes “Drew” as explained below. Additional details regarding generating a contact request component are provided below in relation to FIG. 7. After generating a contact request component for each match, the method 500 can proceed to block 510.

At block 510, method 500 can compare portions of the calendar request with dictionary entries and generate semantic request components. For example, this comparison can be for substrings of the calendar request or substrings that remain once the text corresponding to other identified request components have been removed. In some implementations, using the processor 110, the calendar component 138 of the client device 108 can perform the comparison (using a dictionary 120 local to the client device or by querying a dictionary 120 located on a server) and generate semantic request components when there is a match. In some implementations, the comparison can be performed by the calendar server 102 or the service server 104, e.g., using the dictionary 120. After comparing portions of the calendar request with text in a dictionary to identify semantic request components, the method 500 can proceed to block 512.

At block 512, method 500 can apply an other parsing rule to the rest of the calendar request. For example, using the processor 110, the calendar request module 122 of the client device 108 can apply the other parsing rule to the rest of the calendar request. In some implementations, the calendar server 102 or the service server 104 can apply the other parsing rule to the rest of the calendar request. The other parsing rule can identify text or phrases that can be ignored or excluded from the calendar request. In addition, at block 512, method 500 can apply a rule to identify any remaining portions of the calendar request that have not been identified or removed for other request components as string type request components. After applying the other parsing rule to the rest of the calendar request and/or creating string request components, the method 500 can proceed to block 514.

At block 514, the method 500 can compute an aggregate for the calendar request based on any generated semantic request components. In some implementations, using the processor 110, the calendar component 138 of the client device 108 can compute an aggregate for the calendar request based on the generated semantic request components. In some implementations calendar server 102 or the service server 104 can compute an aggregate for the calendar request based on a comparison of counts of the generated semantic request components. The aggregate can also include additional data based on a count of certain action types included in the aggregate. For example, the aggregate can have an “add” type based on there being more request components of the add type than request components with other action types (e.g. search, cancel, help, etc.) in the aggregate. The aggregate can also specify an object type for certain actions, such as where the action is an “add,” the object can be what is to be added (e.g. meeting, reminder, task, etc.), which can be based on counts of the add type request components that have that corresponding object. In some implementations, if there are no semantic request components, if there are an equal highest number of semantic components with the same type, or, if the system requires a threshold amount of distinction between the two highest counts of semantic component types and that threshold isn't reached, the system can resolve the ambiguity. In some implementations, the system can resolve the ambiguity by selecting a default action. In some implementations, the system can resolve the ambiguity by querying the user to select the intended action. After computing an aggregate for the calendar request, the method 500 can proceed to block 516.

At block 516, the method 500 can identify one or more target calendars based on any generated contact request components. In some implementations, using the processor 110, the calendar component 138 of the client device 108 can identify one or more target calendars based on any generated contact request components. In some implementations calendar server 102 or the service server 104 can identify one or more target calendars based on any generated contact request components. In some implementations, the target calendars can automatically include the calendar of the user who made the calendar request. In some implementations, the target calendars can automatically include the calendar of the user who made the calendar request for specific action types such as creating a new meeting or canceling or modifying an existing meeting. Target calendars can be the calendars in relation to which the system will perform the action associated with the aggregate identified at block 514 and can include, e.g. calendars of the invitees to a new or updated meeting, one or more calendars to perform a search on, the calendar of the requester or of an organization associated with the requester, calendars of contacts otherwise identified in the calendar request or calendars associated with a location if identified in the calendar request.

In some implementations, where no request component of a particular type is identified or there is an ambiguity between the count for request components (e.g. same number of two or more semantic request components of the same type) generating a request component or generating the aggregate can include using a default values. Alternatively or in addition, where such data is missing or inconclusive, the requester can be queried to provide the missing data, to resolve the ambiguity, or to verify the calendar systems best-guess or default resolution. For example, if the calendar request is “setup a meeting” the calendar system can query the request to indicate one or more invitees for the new meeting.

Method 500 can produce a data structure comprising one or more request components and an associated aggregate. FIG. 6 shows four examples of the parsing four meeting requests into aggregates. In the first example, the calendar request is: schedule meeting “Dropbox Time Patent” for next Monday with Drew 602. As shown, this calendar request is broken into seven request components 604 having three potential contacts for the contact string Drew and an aggregate 606 of add a meeting. In the second example, the calendar request is: search for “Paper Launch” 608. As shown, this calendar request is broken into four request components 610 and an aggregate of search 612. In the third example, the calendar request is: remind me to pick up my friend at the airport 614. As shown, this calendar request is broken into two request components 616 and an aggregate of add reminder 618. In the fourth example, the calendar request is: cancel my meeting at 1 pm 620. As shown, this calendar request is broken into three calendar components 622 and an aggregate of cancel meeting 624.

FIG. 7 illustrates a flowchart for identifying one or more target calendars based on any generated contact request components. Method 700 is provided by way of example, as there are a variety of ways to carry out the method. Method 700 described below can be carried out using the configurations illustrated in FIG. 1 by way of example, and various elements of these figures are referenced in explaining exemplary method 700. Method 700 can begin at block 702. In some implementations, the calendar of the requester can be included by default in the target calendars. For example, when setting up a meeting, the calendar system can assume that the requester wants to be a participant at the meeting. In some implementations, having the requester automatically included in the target calendars can be disabled, e.g. where the requester is often setting up meetings for others where the requester does not attend.

At block 702, method 700 can determine if there are any contact request components that have not been operated on by the loop between blocks 704-708. For example, using the processor 110, the calendar component 138 of the client device 108 can make this determination. In some implementations, the calendar server 102 or the service server 104 can make this determination. If there are any such contact request components, the method 700 can proceed to block 704; if not, the method 700 can proceed to block 508 of FIG. 5.

At block 704, method 700 can select a set of contact request components that were generated based on a match to the same portion of the calendar request. For example, using the processor 110, the calendar component 138 of the client device 108 can perform this selection. In some implementations, the calendar server 102 or the service server 104 can perform this selection. For example, if the calendar request included “Bo” and the requester only has “Bo Smith” listed in the one or more contact lists associated with the requester, then Bo Smith is selected in the set of contact request components. Alternatively, if the calendar request included “Robert” and, because there were three Roberts in the requester's calendar, there are three contact request components that this instance of Robert generated, thus these three contact request components can be selected in the set of contact request components. In some implementations, if a group name was entered in the calendar request, each member of the group can be selected as an identified meeting invitee. For example, if “IT group” was entered in the calendar request, each member in the IT group, can be selected as an identified meeting invitee. After selecting the set of contact request components, the method 700 can proceed to block 706.

At block 706, method 700 can cause client device 108 to output a list of contacts corresponding to the set of contact request components selected at block 702. For example, using the processor 110, the calendar component 138 of the client device 108 can output a list of contacts. For example, the list of contacts can be displayed on the display 130 of the client device 108 calendar request. Alternatively, using the processor 110, the calendar component 138 of the client device 108 can cause a list of the contacts to be played on the speaker 140 of the client device 108. For example, as shown in FIG. 4C, the user is prompted to select the desired invitee from a contact list of four Drews: “Drew Betzer, Drew Greenslate, Drew Houston and Drew Werner.” In some implementations, the calendar server 102 or the service server 104 can cause the outputting of the list of contacts by providing the list of contacts to the client device 108 to be outputted as described above. After causing the output of a list of contacts, the method 700 can proceed to block 708.

At block 708, method 700 can receive a selection of a contact from the outputted list. For example, using the processor 110, the calendar component 138 of the client device 108 can receive the selection. In some implementations, using the processor 110, the calendar component 138 can receive a selection of a contact in response to the requester selecting a contact from the list of contacts that is displayed calendar request. Alternatively, using the processor 110, the calendar component 138 of the client device 108 can receive a selection of a contact in response to the requester saying the name of the selected contact calendar request. In some implementations, block 708 is performed by calendar server 102 or the service server 104 receiving the selection from the client device 108. Method 700 can then select, as a target calendar for the calendar request, a calendar associated with the selected contact. After receiving a selection of a contact and identifying a corresponding target calendar, the method 700 can proceed back to block 702 to determine if there are more sets of contact request components to be operated on by the loop between blocks 702-708.

In some implementations, the method 700 can automatically select one or more contacts corresponding to the contact request component, skipping the portions of blocks 706 and 708 that include causing the client device to output the list of contacts and receiving a selection of a contact. This can occur, for example, where only one contact matches the contact request component. This can also occur where the system can use other indicia to automatically select the contact(s) corresponding to a request component, such as based on a determined affinity between the user who performed the calendar request and the selected contact(s). For example, the system can determine affinity values based on one or more of: a content item sharing history between users; a history of social media interactions between users; similarity of known user characteristics between users (e.g. location, age, occupation, group membership, etc.); common calendar history between users (e.g. recent or total number of common attended events); identified friends; etc.; or any combination thereof. In some implementations, an affinity value based on a combination of one or more of these characteristics can be compared to a threshold value, and if the affinity value is not above the threshold value then the system performs the causing the client device to output the list of contacts and receiving a selection of a contact.

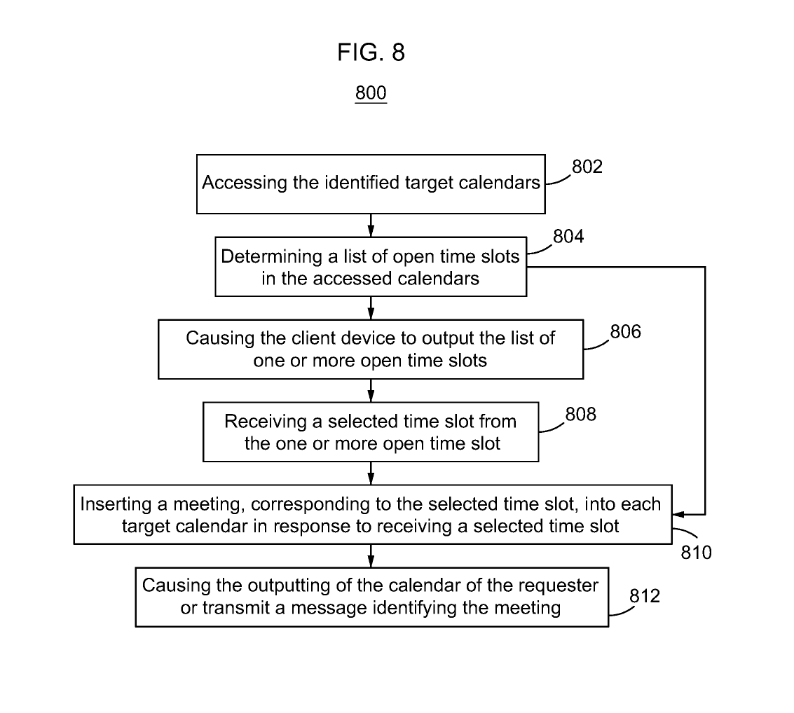

FIG. 8 illustrates a flowchart for scheduling a new meeting. Method 800 is provided by way of example, as there are a variety of ways to carry out the method. Method 800 described below can be carried out using the configurations illustrated in FIG. 1 by way of example, and various elements of these figures are referenced in explaining exemplary method 800. Method 800 can begin at block 802. In some implementations, the calendar of the requester can be included by default in the target calendars. For example, when setting up a meeting, the calendar system can assume that the requester wants to be a participant at the meeting. In some implementations, having the requester be automatically included in the target calendars can be disabled, e.g. where the requester is often setting up meetings for others where the requester does not attend.

At block 802, method 800 can access the identified target calendars. In some implementations, using the processor 110, the calendar component 138 of the client device 108 can accesses the target calendars. The target calendars are the calendars associated with the requester and the identified contacts, e.g., one or more determined contacts from method 700. In some implementations, if the calendar request included a meeting location (e.g., a location request component), such as conference room A, a calendar associated with the meeting location can be a target calendar and be used in determining the list of open time slots. In some implementations, the service server 104 or calendar server 102 can access the target calendars. In some implementations, the target calendars can be accessed from the calendar server 102, e.g. using an API call. Accessing the target calendars, for a new or update to a meeting can include receiving sets of calendar appointments for each target calendar. After accessing the identified target calendars, the method 800 can proceed to block 804.

At block 804, method 800 can determine a list of open time slots in the accessed calendars. In some implementations, using the processor 110, the calendar component 138 of the client device 108 can determine the list of open time slots. In some implementations, calendar request service server 104 or calendar server 102 can determine or compute the list of open time slots. In some implementations, determining the list of open time slots can be performed by receiving a set of calendar items for each target calendar and slots opens slots can be located by finding slots that are taken by none of the items. The list of open time slots can be constrained based on one or more of the request components. For example, open time slots can be determined based on being on a date or within a date range indicated by a date request component or based on being at least as large as a duration request component. The number of open time slots can be limited to a predetermined number of open time slots, e.g., the next ten open time slots. The list of open time slots can include one or more open time slots or two or more open time slots. The list of open time slots may not include time slots that are not available for the requester or one or more of the contacts identified in the calendar request.

In some implementations, a calendar can be assigned a category (e.g. based on the contact identified, keywords in the calendar request, based on a location identified, based on a duration, etc.) and open time slots can be further limited to one or more timeframes (or date ranges) that match that assigned category. For example, a calendar request can include the word “work” such as “setup a new work meeting for me and Homer.” Due to the word “work” being in the calendar request, which can be identified based on a dictionary mapping, the resulting aggregate for this calendar request can indicate to add a new work type meeting. As another example, a calendar request can be “update my meeting with Alicia to be tomorrow.” The calendar system can identify that Alicia is a co-worker of the requester, and thus classify the meeting update as an update to a work meeting. In yet another example, a calendar request can be “9 PM movie with Fred at AMC Theatre.” The calendar system can identify that Fred is a friend of the requester, and thus classified as add a new private type meeting. The calendar system can have identified timeframes for types of meeting (e.g. only starting from 9 am and not ending after 5:30 pm for work meetings, only during certain dates for meetings in particular locations, etc.). In some implementations, these timeframes can be setup by default. In some implementations, a user can adjust the timeframe. In some implementations, the users can add new categories and associated timeframes. After determining a list of one or more open time slots in the calendars, the method 800 can proceed to block 806.

At block 806, method 800 can cause client device 108 to output the list of one or more open time slots. For example, using the processor 110, the calendar component 138 of the client device 108 can output the list of one or more time slots. In some implementations, using the processor 110, the calendar component 138 of the client device 108 can render the list of one or more time slots on the display 130 of the client device 108 if the calendar was a text entry. Alternatively, using the processor 110, the calendar component 138 of the client device 108 can cause the list of one or more open time slots to be played on the speaker 140 of the client device 108 if the request was an audio entry. For example, as shown in FIG. 4D, a list of ten open time slots is rendered on the display 130 of the client device 108. In some implementations, block 806 can be performed by the calendar server 102 or the service server 104 transmitting the list of one or more open time slots to the client device 108 to be outputted as described above. After outputting the list of one or more time slots, the method 800 can proceed to block 808.

At block 808, method 800 can receive a selected time slot from the one or more open time slots. In some implementations, using the processor 110, the calendar component 138 of the client device 108 can receive a selected time slot from the one or more open time slots. In some implementations, using the processor 110, the calendar component 138 of the client device 108 can receive a selection of a time slot in response to the requester selecting a time slot from the one or more time slots rendered on the display 130 of the client device 108 if the request was a text entry. Alternatively, using the processor 110, the calendar component 138 of the client device 108 can receive a selection of a time slot in response to the requester saying the time slot if the request was an audio entry. For example, the requester can say “February 25,” “Thursday February 25” or “Thursday Feb. 25, 2016 at 2 pm” to select a time slot. After receiving a selected open time slot, the method 800 can proceed to block 810.

In some implementations, block 808 can be performed by the calendar server 102 or the service server 104 receiving an indication of user input from client device 108. In some implementations, method 800 does not perform steps 806 and 808 and instead picks a default open time slot, such as the next available one. In some implementations, method 800 does not perform steps 806 or 808 and instead picks an open time slot when there is only one open time slot or only one open time slot within a threshold amount of time of the time the request was made. In some implementations, method 800 performs steps 806 or 808 by automatically picking one or more of the open time slots and providing a request for the user to verify the selection. After receiving a selected time slot, the method 800 can proceed to block 810.

At block 810, method 800 can insert a meeting, corresponding to the selected time slot, into each target calendar in response to receiving a selected time slot. In some implementations, where the calendar request is an update of a previously scheduled meeting, block 810 can also include changing or removing the previously scheduled meeting. In some implementations, in response to receiving the selected time slot, using the processor 110, the calendar component 138 of the client device 108 can send a meeting command to the calendar server 102 and/or the service server 104 to have the meeting inserted. In some implementations, sending the insert command can be from calendar server 102 or the service server 104. The inserted meeting can include a list of meeting invitees. Alternatively, using the processor 110, the calendar component 138 of the client device 108 can send one or more meeting invites to the identified meeting invitees. In some implementations, calendar request service server 104 or calendar server 102 can send the one or more meeting invites to the identified meeting invitees. Once the one or more meeting invites are accepted by the meeting invitees, the meeting, corresponding to the selected time slot, can be inserted into each target calendar. After inserting the meeting into each calendar, the method 800 can proceed to block 812.

At block 812, method 800 can cause the outputting of the calendar of the requester or transmit a message identifying the meeting. In some implementations, using the processor 110, the calendar component 138 of the client device 108 can output the calendar of the requester on the display 130 of the client device 108 associated with the requester. The outputted calendar can include the message identifying the meeting. For example, as shown in FIG. 4E, the calendar of the requester includes a message, “Meeting on Thursday Feb. 35, 3016 at 02:00 PM created!” is rendered on the display 130 of the client device 108. In some implementations, the calendar server 102 and/or the service server 104 can send a message to the meeting invitees informing them of the newly inserted meeting. The message can be a text message, an email message, a modal notification, or other types of messages.

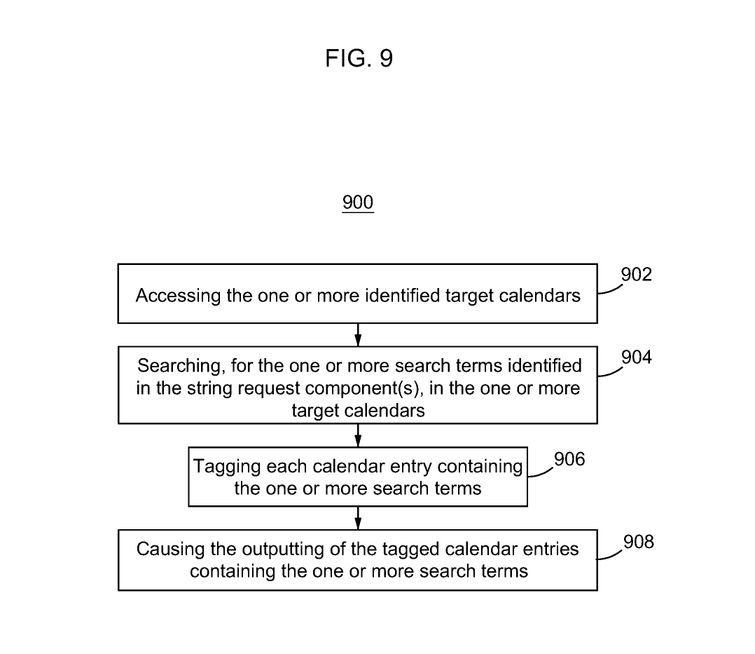

FIG. 9 illustrates a flowchart for performing a search. Method 900 is provided by way of example, as there are a variety of ways to carry out the method. Method 900 described below can be carried out using the configurations illustrated in FIG. 1 by way of example, and various elements of these figures are referenced in explaining exemplary method 900. Method 900 can begin at block 902.

At block 902, method 900 can access the identified one or more target calendars. In some implementations, using the processor 110, the calendar component 138 of the client device 108 can access the target calendars. The target calendars can be the calendar associated with a contact identified in the calendar request or if no one is identified the target calendar can be the calendar of the requester, e.g., the default target calendar. In some implementations, the target calendar can be accessed from the calendar server 102, e.g., using an API call. After accessing the identified target calendar, the method 900 can proceed to block 904.

At block 904, method 900 can search, for the one or more search terms identified in the string request component(s), in the one or more target calendars. In some implementations, using the processor 110, the calendar component 138 of the client device 108 can search, for the one or more search terms identified in the string request component(s), in the one or more target calendars. In some implementations, the calendar server 102 or the service server 104 can perform the search. The search can be exact or threshold. Exact matching can require the text or phrases in the calendar request to be identical to text or phrases in the dictionary. Threshold matching can use wildcards; related words; a threshold amount of letter/word transpositions, omissions, or insertions; etc. A wildcard can be used to represent a number of characters, e.g., meet*, where the * is the wildcard and can capture meet, meets, meeting, etc. Related words can include variations of a word, such as “ave” could match with “avenue.” After searching for the one or more search terms, the method 900 can proceed to block 906.

At block 906, method 900 can tag each calendar entry containing the one or more search terms. In some implementations, using the processor 110, the calendar component 138 of the client device 108 can tag each calendar entry containing the one or more search terms. In some implementations, the calendar server 102 or the service server 104 can tag each calendar entry. After tagging each calendar entry containing the one or more search terms, the method 900 can proceed to block 908.

At block 908, method 900 can cause the outputting of the tagged calendar entries containing the one or more search terms. In some implementations, using the processor 110, the calendar component 138 of the client device 108 can cause the outputting of the tagged calendar entries containing the one or more search terms on the display 130 of the client device 108 associated with the requester. In some implementations, the calendar server 102 or the service server 104 can transmit the tagged calendar entries to the client device 108 for outputting.

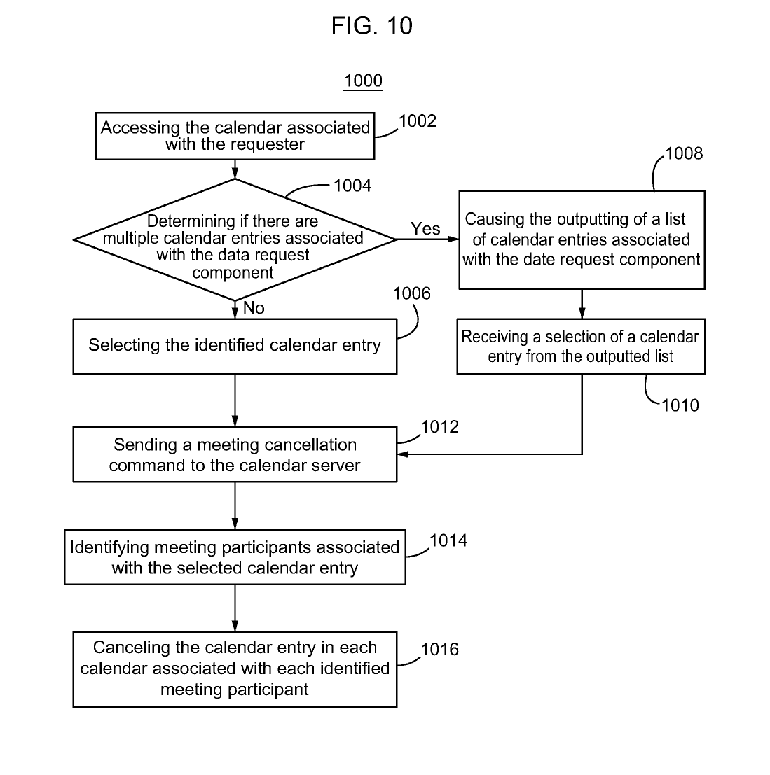

FIG. 10 illustrates a flowchart for canceling a meeting. Method 1000 is provided by way of example, as there are a variety of ways to carry out the method. Method 1000 described below can be carried out using the configurations illustrated in FIG. 1 by way of example, and various elements of these figures are referenced in explaining exemplary method 1000. Method 1000 can begin at block 1002.

At block 1002, method 1000 can access the calendar associated with the requester. In some implementations, using the processor 132, the calendar component 138 of the client device 108 can access the calendar associated with the requester. In some implementations, the service server 104 or calendar server 102 can access the calendar associated with the requester. In some implementations, the calendar can be accessed from the calendar server 102, e.g. using an API call. Accessing the target calendar for a cancellation can include receiving a set of calendar appointments associated with the date request component. In some implementations, method 1000 can access a target calendar other than the calendar of the requestor, such as is described in relation to block 516. For example, a personal assistant with appropriate permissions can provide a calendar request to cancel his boss's Tuesday 2:00 meeting. After accessing the calendar associated with the requester, the method 1000 can proceed to block 1004.

At block 1004, method 1000 can determine if there are multiple calendar entries associated with the data request component. In some implementations, using the processor 132, the calendar component 138 of the client device 108 can determine if there are multiple calendar entries associated with the date request component. In some implementations, the service server 104 or the calendar server 102 can determine if there are multiple calendar entries associated with the date request component. For example, if the calendar request is “cancel my appointment on Monday,” the calendar system 100 needs to determine which calendar entry the requester is referring to on Monday. If there are multiple appointments, the method 1000 can proceed to block 1008. If there is only one calendar entry or if the requester identified the calendar entry with sufficient detail, e.g., “cancel my meeting on Monday at 1,” the method can proceed to block 1006.

At block 1006, method 1000 can select the identified calendar entry. In some implementations, using the processor 132, the calendar component 138 of the client device 108 can select the identified calendar entry. In some implementations, the service server 104 or calendar server 102 can select the identified calendar entry. After selecting the calendar entry, the method 1000 can proceed to block 1012.

At block 1008, method 1000 can cause the outputting of a list of calendar entries associated with the date request component. For example, using the processor 110, the calendar component 138 of the client device 108 can cause the outputting of a list of calendar entries associated with the date request component. In some implementations, using the processor 110, the calendar component 138 of the client device 108 can render the list of calendar entries associated with the date request component on the display 130 of the client device 108 if the calendar was a text entry. Alternatively, using the processor 110, the calendar component 138 of the client device 108 can cause data from the list of calendar entries associated with the date request component to be played on the speaker 140 of the client device 108, e.g., if the request was an audio entry. In some implementations, block 1008 can be performed by the calendar server 102 or the service server 104 transmitting the list of calendar entries associated with the date request component to the client device 108 to be outputted as described above. After outputting the list of calendar entries associated with the date request component, the method 1000 can proceed to block 1010.

At block 1010, method 1000 can receive a selection of a calendar entry from the outputted list. For example, using the processor 110, the calendar component 138 of the client device 108 can receive the selection. In some implementations, using the processor 110, the calendar component 138 of the client device 108 can receive a selection of a calendar entry in response to the requester selecting a calendar entry from the list of contacts that is displayed calendar request. Alternatively, using the processor 110, the calendar component 138 of the client device 108 can receive a selection of a calendar entry in response to the requester saying the time of the selected calendar entry. In some implementations, block 1010 is performed by calendar server 102 or the service server 104 receiving the selection from client device 108. After receiving a selection of a calendar entry from the outputted list, the method 1000 can proceed to block 1012.

At block 1012, method 1000 can send a meeting cancellation command to the calendar server 102. For example, using the processor 110, the calendar component 138 of the client device 108 can send a meeting cancellation command to the calendar server 103. In some implementations, the service server 104 can send a meeting cancellation to the calendar server 102. The meeting cancellation can include the date request component which has an associated timestamp for the meeting to be cancelled. After sending the meeting cancellation command to the calendar server 102, the method can proceed to block 1014.

At block 1014, method 1000 can identify meeting participants associated with the selected calendar entry. In some implementations, the calendar server 102 can identify meeting participants associated with the selected calendar entry. The meeting participants can be saved or associated with the calendar entry when the calendar entry is created. After identifying meeting participants associated with the selected calendar entry, the method 1000 can proceed to block 1016.

At block 1016, method 1000 can cancel the calendar entry in each calendar associated with each identified meeting participant. In some implementations, the calendar server 102 can cancel the calendar entry in each calendar associated with each identified meeting participant. The calendar server 102 can then cause the calendar entry to be removed from the calendars of each identified meeting participant associated with the calendar entry. For example, if the requester, Bob Smith and Susan Smith have a meeting on Tuesday, the calendar entry for the meeting can be removed from the calendars associated with the requester, Bob Smith and can be removed from the calendars associated with Susan Smith. In some implementations, the targeted calendar entry can be indicated as canceled. For example, the calendar entry can be shown in a different color (e.g., red) or different shade from other calendar entries to indicate that the calendar entry is canceled. In some implementations, the targeted calendar entry can have an “X” in the corresponding time slot to indicate that the calendar entry is canceled. Other indications can be used to show a canceled calendar entry. In some implementations, the requester can be prompted to confirm the identified calendar entry prior to canceling the calendar entry.

When the calendar entry is a request to modify a calendar entry, e.g., re-schedule or to shift the meeting time, the calendar system can identify the originally scheduled calendar entry and can obtain the target calendars of the contacts associated with the originally scheduled calendar entry. The calendar system can check the targeted calendars to ensure that the modification has no conflicts in the targeted calendars. For example, if the requester requests that a meeting be extended an hour, the calendar system can check to see if any of the participants have any conflicts. If a participant has a conflict due to the modification calendar request, the request to modify the calendar entry can be treated as a new meeting request and can identify open time slots for a meeting in accordance with the duration of the request and the target calendars of the participants.

In some implementations, a user can have multiple calendars. For example, a user can have a work calendar and a social calendar. The calendars can be based on working hours associated with a user. For example, a user can set his or her working hours to Monday through Friday with each day starting at 8 AM and ending at 5 PM. Based on the requester identifying a calendar, people identified in a calendar request and/or a time associated with a calendar request, the work calendar or social calendar can be used. For example, if a calendar request is: “schedule dinner with Susan Doe at 7 PM”, the calendar system can schedule a meeting on a social calendar associated with the requester since Susan is listed in a friend contact list and the meeting is scheduled outside of the working hours associated with the requester.

### Exemplary System

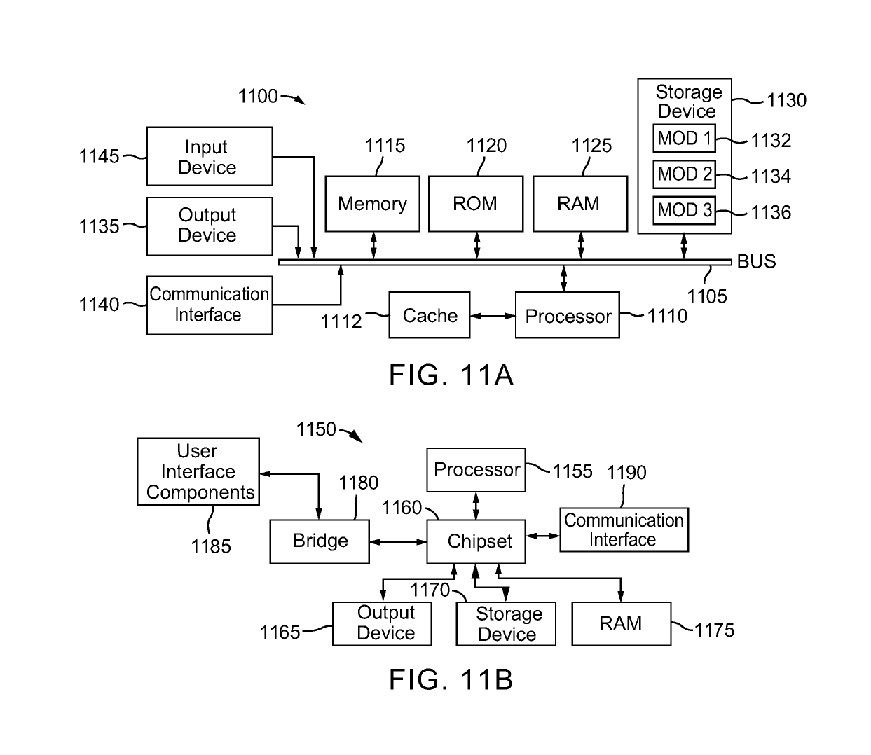

FIGS. 11A and 11B show exemplary possible system embodiments. The more appropriate embodiment will be apparent to those of ordinary skill in the art when practicing the present technology. Persons of ordinary skill in the art will also readily appreciate that other system embodiments are possible.

FIG. 11A illustrates a conventional system bus computing system architecture 1100 wherein the components of the system are in electrical communication with each other using a bus 1105. Exemplary system 1100 includes a processing unit (CPU or processor) 1110 and a system bus 1105 that couples various system components including the system memory 1115, such as read only memory (ROM) 1120 and random access memory (RAM) 1125, to the processor 1110. The system 1100 can include a cache of high-speed memory connected directly with, in close proximity to, or integrated as part of the processor 1110. The system 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other system memory 1115 may be available for use as well. The memory 1115 can include multiple different types of memory with different performance characteristics. The processor 1110 can include any general purpose processor and a hardware module or software module, such as module 1 1132, module 2 1134, and module 3 1136 stored in storage device 1130, configured to control the processor 1110 as well as a special-purpose processor where software instructions are incorporated into the actual processor design. The processor 1110 may essentially be a completely self-contained computing system, containing multiple cores or processors, a bus, memory controller, cache, etc. A multi-core processor may be symmetric or asymmetric.

To enable user interaction with the computing device 108, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art. In some instances, multimodal systems can enable a user to provide multiple types of input to communicate with the computing device 1100. The communications interface 1140 can generally govern and manage the user input and system output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof.

The storage device 1130 can include software modules 1132, 1134, 1136 for controlling the processor 1110. Other hardware or software modules are contemplated. The storage device 1130 can be connected to the system bus 1105. In one aspect, a hardware module that performs a particular function can include the software component stored in a computer-readable medium in connection with the necessary hardware components, such as the processor 1110, bus 1105, output device 1135, e.g., display 130, speaker 140, and so forth, to carry out the function.

FIG. 11B illustrates a computer system 1150 having a chipset architecture that can be used in executing the described method and generating and displaying a graphical UI (GUI). Computer system 1150 is an example of computer hardware, software, and firmware that can be used to implement the disclosed technology. System 1150 can include a processor 1155, representative of any number of physically and/or logically distinct resources capable of executing software, firmware, and hardware configured to perform identified computations. Processor 1155 can communicate with a chipset 1160 that can control input to and output from processor 1155. In this example, chipset 1160 outputs information to output 1165, such as a display, and can read and write information to storage device 11110, which can include magnetic media, and solid state media, for example. Chipset 1160 can also read data from and write data to RAM 11115. A bridge 1180 for interfacing with a variety of UI components 1185 can be provided for interfacing with chipset 1160. Such UI components 1185 can include a keyboard, a microphone, touch detection and processing circuitry, a pointing device, such as a mouse, and so on. In general, inputs to system 1150 can come from any of a variety of sources, machine generated and/or human generated.

Chipset 1160 can also interface with one or more communication interfaces 1190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 1155 analyzing data stored in storage 11110 or 11115. Further, the machine can receive inputs from a user via UI components 1185 and execute appropriate functions, such as browsing functions by interpreting these inputs using processor 1155.

It can be appreciated that exemplary systems 1100 and 1150 can have more than one processor 1110 or be part of a group or cluster of computing devices networked together to provide greater processing capability.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

In this description, the terms “module” and “component” are used interchangeably. In this description, the term “module” refers to a physical computer structure encoding computational logic that provides the specified functionality. A module can be implemented in hardware, firmware, and/or software. In regards to software implementations of modules, a module can comprise a block of code that contains the data structure, methods, classes, header and other code and data objects appropriate to execute the described functionality. Depending on the specific implementation language, a module may be, e.g., a package, a class, a function, a script, or a component. Examples of languages that support modules include Ada, Algol, BlitzMax, COBOL, D, Dart, Erlang, F, Fortran, Go, Haskell, IBM/360 Assembler, IBM i Control Language (CL), IBM RPG, Java, MATLAB, ML, Modula, Modula-2, Modula-3, Morpho, NEWP, JavaScript, Oberon, Oberon-2, Objective-C, OCaml, several derivatives of Pascal (Component Pascal, Object Pascal, Turbo Pascal, UCSD Pascal), Perl, PL/I, PureBasic, Python, C, C++, C#, and Ruby, though other languages may support equivalent structures using a different terminology than “module.”

It will be understood that the named modules described herein represent one embodiment of such modules, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

As used herein, being above a threshold means that a value for an item under comparison is above a specified other value, that an item under comparison is among a certain specified number of items with the largest value, or that an item under comparison has a value within a specified top percentage amount. As used herein, being below a threshold means that a value for an item under comparison is below a specified other amount, that an item under comparison is among a certain specified number of items with the smallest value, or that an item under comparison has a value within a specified bottom percentage amount. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer implemented method comprising:
parsing a calendar request and generating one or more request components,
wherein the calendar request is based on a natural language input,
wherein the one or more request components include a contact request component identifying a meeting invitee, and
wherein the meeting invitee is identified based on a comparison between text from the calendar request and one or more contacts of a requester who initiated the calendar request;
identifying target calendars including at least (A) a calendar associated with the requester and (B) a calendar associated with the meeting invitee;
determining a list of open time slots, wherein each open time slot in the list of open time slots is selected based on that time slot being open in each of the target calendars;
sending, to a client device associated with the requester, the list of open time slots;
receiving a selection of a meeting time slot, selected from the list of open time slots; and
in response to receiving the selection, causing an invitation for a new meeting to be sent to the meeting invitee.

2. The computer implemented method of claim 1, wherein the parsing the calendar request and generating the one or more request components further comprises:
comparing content from the calendar request to one or more mappings that map terms or phrases to semantics; and
generating at least one semantic request component based on one or more matches between the text from the calendar request and the one or more mappings;
wherein the method further comprises determining, based on the at least one semantic request component, that the calendar request is a request to setup a new meeting; and
wherein the determining the list of open time slots and causing an invitation for a new meeting to be sent to the meeting invitee are both in response to the determining that the calendar request is a request to setup a new meeting.

3. The computer implemented method of claim 1, wherein the natural language input is text input or audio input.

4. The computer implemented method of claim 1, wherein the parsing the calendar request to generate one or more request components further comprises selecting content between quotation marks to generate a string request component; and wherein a title for the new meeting is determined based on the string request component.

5. The computer implemented method of claim 1, further comprising:
causing a calendar application to render a calendar interface, including a text input field, on a display of a client device, the calendar interface displaying a representation of the calendar associated with the requester,
wherein the received calendar request was entered as text to the text input field; and
wherein the sending the list of open time slots causes rendering of the list of open time slots on a display of the client device.

6. The computer implemented method of claim 1,
wherein the comparison between text from the calendar request and one or more contacts of a requester comprises accessing one or more contact lists associated with the requester;
wherein the parsing the calendar request and generating the one or more request components further comprises generating the at least one contact request component based on one or more matches between the text from of the calendar request and the one or more contact entries in the one or more accessed contacts lists; and
wherein at least one of the generated contact request components includes information, taken from the accessed contact list, that was not part of the calendar request.

7. The computer implemented method of claim 1, wherein the parsing the calendar request and generating the one or more request components further comprises:
identifying content from the calendar request as indicating a duration; and
generating a duration request component, the duration request components including a computed duration value based on a corresponding portion of the calendar request,
wherein the determining the list of open time slots comprises determining open time slots that are as large as the duration value.

8. The computer implemented method of claim 1, wherein the parsing the calendar request and generating the one or more request components further comprises:
identifying content from the calendar request as indicating a date; and
generating a date request component, the date request components including a computed date value based on a corresponding portion of the calendar request,
wherein the determining the list of open time slots comprises determining open time slots that match the date value.

9. The computer implemented method of claim 1, wherein determining the list of open time slots comprises:
determining a category for the calendar request; and
limiting the list of open time slots to open time slots that fall within a timeframe or date range established for the category.

10. The computer implemented method of claim 1 wherein determining the list of open time slots further comprises limiting the number of open time slots to a predetermined number of open time slots.

11. A non-transitory computer-readable medium storing computer-executable code that, when executed by a computing system, cause the computing system to perform operations comprising:
receiving a calendar request;
parsing the calendar request and generating one or more request components;
identifying one or more target calendars including at least one calendar associated with a contact of a requester who initiated the request;
determining open time slots, wherein each particular open time slot of the open time slots is selected based on that particular time slot being open in each of the target calendars;
receiving a selection of a meeting time slot, selected from the open time slots; and
in response to receiving the selection, causing a new meeting to be added, in the meeting time slot, to a calendar of the requester.

12. The non-transitory computer-readable medium of claim 11, wherein the causing the new meeting to be added, in the meeting time slot, to the calendar of the requestor comprises:
sending a meeting command to a calendar server to have the new meeting created.

13. The non-transitory computer-readable medium of claim 11, wherein the selection of a meeting time slot is received from a client device, the selection received in response to the sending of the list of open time slots to the client device.

14. The non-transitory computer-readable medium of claim 11, wherein the calendar request is a natural language request.

15. The non-transitory computer-readable medium of claim 11, wherein the operations further comprise:
causing a calendar application to render a calendar interface, including a text input field, on a display of a client device, the calendar interface displaying a representation of the calendar associated with the requester,
wherein the received calendar request was entered as text to the text input field; and
wherein the sending the list of open time slots causes rendering of the list of open time slots on a display of the client device.

16. The non-transitory computer-readable medium of claim 11, wherein the parsing the calendar request and generating the one or more request components further comprises:
comparing content from the calendar request to one or more mappings that map terms or phrases to semantics; and
generating at least one semantic request component based on one or more matches between the text from the calendar request and the one or more mappings;
wherein the method further comprises determining, based on the at least one semantic request component, that the calendar request is a request to setup a new meeting; and
wherein the determining the list of open time slots and causing an invitation for a new meeting to be sent to the invitee are both in response to the determining that the calendar request is a request to setup a new meeting.

17. The non-transitory computer-readable medium of claim 16, wherein the parsing the calendar request and generating the one or more request components further comprises:
identifying content from the calendar request as indicating a duration; and
generating a duration request component, the duration request components including a computed duration value based on a corresponding portion of the calendar request,
wherein the determining the list of open time slots comprises determining open time slots that are as large as the duration value.

18. The non-transitory computer-readable medium of claim 16, wherein the parsing the calendar request and generating the one or more request components further comprises:
identifying content from the calendar request as indicating a date; and
generating a date request component, the date request components including a computed date value based on a corresponding portion of the calendar request,
wherein the determining the list of open time slots comprises determining open time slots that match the date value.

19. The non-transitory computer-readable medium of claim 11,
wherein the identifying the one or more target calendars including the at least one calendar associated with a contact of a requester who initiated the request is based on a comparison between text from the calendar request and one or more contacts of the requester, wherein the comparison comprises accessing a contact list associated with the requester;
wherein the parsing the calendar request and generating the one or more request components further comprises generating the at least one contact request component based on one or more matches between the text from of the calendar request and the one or more contact entries in the one or more accessed contacts lists; and
wherein at least one of the generated contact request components includes information, taken from the accessed contact list, that was not part of the calendar request.

20. An apparatus comprising:
a memory configured to store instructions; and
a processor configured to execute instructions to:
receive, from a requester, a calendar request that identifies a meeting invitee;
parse the calendar request and generate one or more request components, wherein at least one of the request components identifies a meeting invitee;
identify one or more target calendars including at least a calendar associated with the meeting invitee, wherein the calendar associated with the meeting invitee is identified based on a comparison of text of the calendar request with contacts of the requestor;
determine open time slots, wherein each particular open time slot of the open time slots is selected based on that particular time slot being open in each of the one or more target calendars;
send, to a client device associated with the requester, indications of the open time slots; and
receive, from the client device, a selection of a meeting time slot, selected from the open time slots.
